(19) United States
(12) Patent Application Publication
(10) Pub. No.: US 2013/0029025 A1
(43) Pub. Date: Jan. 31, 2013

(54) REDUCED FAT BAKERY EMULSION AND USE OF SUCH AN EMULSION IN THE PREPARATION OF PUFF PASTRY

(71) Applicants: Laurent Marc Vessière, Antwerpen (BE); Marc Marcel Mathilde de Mol, Wijnegem (BE)

(72) Inventors: Laurent Marc Vessière, Antwerpen (BE); Marc Marcel Mathilde de Mol, Wijnegem (BE)

(21) Appl. No.: 13/582,024

(22) PCT Filed: Oct. 8, 2010
(86) PCT No.: PCT/NL10/50666

§ 371 Date: Oct. 16, 2012

(30) Foreign Application Priority Data
Mar. 1, 2010 (EP) 10155007.7

(51) Int. Cl. A21D 2/08; A21D 13/08; A21D 8/02; A21D 10/00

(52) U.S. Cl. 426/550; 426/549; 426/556

(57) ABSTRACT

The present invention relates to a reduced fat bakery emulsion comprising 39-65 wt. % of a continuous fat phase and 35-61 wt. % of a dispersed aqueous phase, said aqueous phase having the following composition:
60-80 wt. % of water;
18-40 wt. % of maltodextrin with a DE in the range of 1-5;
0-5 wt. % of other hydrocolloids;
0-6 wt. % of dissolved components selected from acids, salts and combinations thereof;
0-2 wt. % of other edible ingredients;
   said continuous fat phase having the following composition:
94-99.5 wt. % of triglycerides;
0.5-5 wt. % of emulsifier;
0-2 wt. % of other edible ingredients;
   wherein the fat phase is characterized by the following solid fat profile:
25%≦N₂₀≦50;
15%≦N₃₀≦35%;
8%≦N₃₅≦30%.

The bakery emulsion of the present invention enables the preparation of low fat puff pastries of high quality.

### TECHNICAL FIELD OF THE INVENTION

The present invention relates to a low fat bakery emulsion. More particularly, the invention provides a low fat bakery margarine that can suitably be used in the preparation of, for instance, puff pastry. The invention further relates to a process of preparing a puff pastry dough using the aforementioned bakery emulsion.

### BACKGROUND OF THE INVENTION

Puff pastry is a light, flaky, unleavened pastry containing several layers of fat which is in solid state at 20° C. Puff pastry is typically prepared from a dough, which is layered with fat and repeatedly folded and rolled to form a laminated dough comprising alternating layers of dough (French method). In a traditional preparation of puff pastry, the dough with fat is turned six times to yield 729 theoretical layers.

Depending upon the procedure employed to prepare the puff pastry dough, the layers of fat and dough within the sheet can extend over the entire or only a portion of the total, surface area of the dough sheets used in the preparation. Variations on the traditional procedure have been made and can also produce successful puff pastry doughs. One such alternative method for preparing puff pastry, which is called the Dutch or Scottish method, comprises addition of small cubes of fat to the flour, followed by kneading the dough while adding water and possibly other bakery ingredients. Next, the dough so obtained is repeatedly folded and rolled to product the puff pastry dough.

Puff pastry can also be leavened with baker's yeast to create croissants or Danish pastry, though such doughs are not universally known as puff pastries.

During baking, puff pastries can significantly increase in height, typically up to eight-fold. Steam is formed during the baking from the water component in the puff pastry dough. When the water evaporates, the dough layers expand. The dough layers are insulated by the fat layers. Such a layering structure of the puff pastry dough allows each of the dough layers and fat layers to cook individually, thereby puffing the pastry. Furthermore, as the gluten in the flour component coagulates in the preparation process, it permits the baked puff pastries to form into a light open structure with fine layers.

The rising and flaking achieved in puff pastry depends on the fat being suitably functional to utilize the vaporization of moisture and the expansion of entrapped air to create the separate layers. The fat must be capable of properly rolling in and maintaining separation of the layers. If the fat is too soft, it will be absorbed into the dough, and the layers will fuse. If the fat is too hard, the dough will tear when it is rolled. In other words, the fat must be highly functional in order to permit formation of the separate layers and maintain them through baking.

Common types of fats (or fat products) used in puff pastry include butter, shortenings and bakery margarines. These fat products typically contain at least 80 wt. % of fat and are typically applied in puff pastry in amounts that exceed 50% by weight of flour. Thus, the fat content of puff pastries tends to be quite high.

In view of the fact that obesity and overweight are becoming increasingly prevalent there is a general need for reducing the caloric content of foodstuffs. Accordingly, it is desirable that the fat content of puff pasty is reduced. However, in puff pastry reduction of fat content poses a particular challenge as fat not only affects the eating quality of the puff pastry but, as explained herein before, fat also largely determines the handling properties of the dough during the lamination process and the volume increase of the dough during baking.

U.S. Pat. No. 6,025,010 describes a fat continuous low fat spread comprising:
a) fat in the range of about 30-60%; and
b) an aqueous phase which is 40-70% of the composition said aqueous phase containing non-gelling hydrocolloids in the range of about 15-40% of the spread,
   wherein said non-gelling hydrocolloid is a maltodextrin of DE 6-10 processed from corn starch using hydrochloric acid and enzymes and wherein said maltodextrin is present at levels ranging from about 15 to about 40% and wherein the maltodextrin is partially digestible and wherein the maltodextrin Beta 1-2, Beta 1-3 and Beta 1-6 bonds of the maltodextrin are not digestible. In the US patent it is stated that the low water content allows the spreads to be used in baking, without affecting the organoleptic properties when the spreads are used in cold uses, for example spread applications.

EP-A 1 611 794 describes a margarine-like composition for laminated doughs comprising 35 to 80 wt. % of a fat phase containing vegetable fats, from 20 to 65 wt. % of an aqueous phase comprising inulin and pectin, and at least one emulsifier.

EP-A 2 153 725 describes a composition for laminated dough comprising 45-65 wt. % of fat phase that contains a mixture of fats and at least one emulsifier; and 35-55 wt. % of an aqueous phase that contains water and at least one thickener. The examples of this Belgian patent describe oil-and-water emulsions comprising 55 wt. % of a fat phase and 45 wt. % of an aqueous phase, said aqueous phase containing 6-7% maltodextrin by weight of the emulsion. The triglyceride component of the fat phase consists of 40% palm oil, 40% palm stearin and 20% rapeseed oil.

### SUMMARY OF THE INVENTION

The present inventors have developed a reduced fat bakery emulsion that enables the preparation of low fat puff pastries that are comparable to high fat pastries made with conventional puff pastry margarine or shortening. The bakery emulsion of the present invention comprising 39-65 wt. % of a continuous fat phase and 35-61 wt. % of a dispersed aqueous phase, said aqueous phase having the following composition:
60-80 wt. % of water;
18-40 wt. % of maltodextrin with a DE in the range of 1-5;
0-5 wt. % of other hydrocolloids;
0-6 wt. % of dissolved components selected from acids, salts and combinations thereof;
0-2 wt. % of other edible ingredients;
   said continuous fat phase having the following composition:
94-99.5 wt. % of triglycerides;
0.5-5 wt. % of emulsifier selected from monoglycerides; diglycerides;
phospholipids; esters of mono- and/or diglycerides and an acid selected from acetic acid, lactic acid, citric acid, tartaric acid and diacetyl tartaric acid, sugar esters of fatty acids, polyglycerol esters of fatty acids, polyglycerol polyricinoleate, propyleneglycol esters of fatty acids, sorbitan esters of fatty acids, stearoyl lactate and combinations thereof;
0-2 wt. % of other edible ingredients;
   wherein the fat phase is further characterized by the following solid fat profile:
25%≦N₂₀≦50;
15%≦N₃₀≦35%;
5%≦N₃₅≦30%.

Despite the fact that it has a substantially lower fat content than the fat products conventionally used in the preparation of puff pastry, the reduced fat bakery emulsion of the present invention can suitably be used to replace these products in the puff pastry recipes on a weight-by-weight basis. Thus, if a bakery emulsion according to the present invention is used instead of a conventional puff pastry margarine the fat content in the final puff pastry is typically reduced with 20-50%.

The bakery emulsion according to the present invention enables the preparation of a puff pastry dough of reduced fat content that has excellent handling properties and that displays excellent volume increase during baking. Furthermore, it was found that the low fat puff pastries produced with the present bakery emulsions have excellent eating quality.

Although the inventors do not wish to be bound by theory, it is believed that the advantageous properties of the bakery emulsion of the present invention are associated with the combined use of (i) a low DE maltodextrin in a concentration of 18-40% by weight of the aqueous phase, (ii) a suitable emulsifier in a concentration of 0.5-5% by weight of the fat phase and (iii) a fat phase having the particular solid fat profile described above.

Besides the bakery emulsion described above, the present invention also relates to a process of preparing a puff pastry dough, said process comprising employing incorporating into said dough or batter 50-120% by weight of flour of such a bakery emulsion.

### DETAILED DESCRIPTION OF THE INVENTION

Accordingly, one aspect of the invention relates to a reduced fat bakery emulsion comprising 39-65 wt. % of a continuous fat phase and 35-61 wt. % of a dispersed aqueous phase, said aqueous phase having the following composition:
60-80 wt. % of water;
18-40 wt. % of maltodextrin with a DE in the range of 1-5;
0-5 wt. % of other hydrocolloids;
0-6 wt. % of dissolved components selected from acids, salts and combinations thereof;
0-2 wt. % of other edible ingredients;
   said continuous fat phase having the following composition:
94-99.5 wt. % of triglycerides;
0.5-5 wt. % of emulsifier selected from monoglycerides; diglycerides;
phospholipids; esters of mono- and/or diglycerides and an acid selected from acetic acid, lactic acid, citric acid, tartaric acid and diacetyl tartaric acid, sugar esters of fatty acids, polyglycerol esters of fatty acids, polyglycerol polyricinoleate, propyleneglycol esters of fatty acids, sorbitan esters of fatty acids, stearoyl lactate and combinations thereof;
0-2 wt. % of other edible ingredients;
   wherein the fat phase is characterized by the following solid fat profile:
25%≦N₂₀≦50;
15%≦N₃₀≦35%;
5%≦N₃₅≦30%.

Throughout this document the terms fat and oil are used interchangeably. Both terms refer to fatty acid glycerol esters such as triglycerides, diglycerides and monoglycerides.

The solid fat profile of the fat phase is determined by measuring the N-value at different temperatures. The N value a temperature x° C. is referred to in here as Nₓ. These N-values can suitably be measured using the generally accepted analytical method that is based on NMR measurements: Sample pre-treatment involves heating to 80° C. 15 minutes, 15 minutes at 60° C., 60 minutes at 0° C. and 30 minutes at the measuring temperature.

The term “hydrocolloid” as used herein encompasses thickeners and gelling agents. Examples of hydrocolloids that may be employed in the present emulsion include gelatine, carrageenan, pectin, inulin, alginate, agar, locust bean gum, xanthan gum, guar gum and combinations thereof.

The term “puff pastry” and “pastry” as used herein refers to a light, flaky pastry containing discrete layers of solid fat that is made from leavened (e.g. Danish pastry or croissant) or unleavened dough.

The terms “wt. %” and “% by weight” both refer to the concentration expressed on a weight-by-weight basis (% (w/w)).

The triglycerides contained in the fat phase may suitably be provided by vegetable oils, milk fat, animal fats, marine oils and combinations thereof. Also fractions of these oils and fats and hydrogenated versions of these oils and fats may be employed. Triglycerides may further be provided by interesterified oils and fats and/or interesterified blends of oils and/or fats.

The aqueous phase and fat phase of the present bakery emulsion together preferably constitute at least 95 wt. %, more preferably at least 99 wt. % of the bakery emulsion. Most preferably, the combination of the aqueous phase and the fat phase makes up the bakery emulsion.

The aqueous phase of the bakery emulsion may contain up to 2 wt. % of other edible ingredients besides maltodextrin, other hydrocolloids, dissolved components and water. Examples of edible ingredients that may be included in the dispersed aqueous phase include non-hydrocolloid protein, fat, flavouring and preservatives. An example of a non-hydrocolloid protein is milk protein.

The fat phase of the emulsion can contain up to 2 wt. % of other edible ingredients besides triglycerides and emulsifiers. Examples of such edible ingredients include colouring, flavouring and anti-oxidants.

The inventors have found that the use of maltodextrin in a high concentration is critical to achieving the benefits of the present invention. Advantageously, the bakery emulsion contains at least 20%, more preferably at least 22% of maltodextrin by weight of the aqueous phase. Preferably the maltodextrin concentration does not exceed 36% by weight of the aqueous phase. Even more preferably the latter concentration does not exceed 35% by weight of the aqueous phase.

Expressed differently, the maltodextrin of the bakery emulsion preferably exceeds 10% by weight of the total emulsion. Most preferably the maltodextrin contained in the bakery emulsion in a concentration of 11-23 wt. %.

The term “dextrose equivalent (DE)” is a term of the art that is used to indicate the degree of hydrolysis of starch. It is the percentage of reducing sugars present on the total amount of starch. All glucose polymers, from the native starch to glucose syrup, have in common that the molecule begins with a reducing sugar, containing a free aldehyde. The more the starch is hydrolysed, the more reducing sugars are present. A complete hydrolysis converts all the starch into glucose (DE 100). Glucose syrups have a DE of at least 20, whilst maltodextrins have a DE below 20. The standard methods to measure the amount of reducing sugars and calculating the dextrose equivalent (DE) are Benedict's reagent and Fehling's test.

According to another preferred embodiment, the maltodextrin contained in the bakery emulsion has a DE in the range of 1.5-4, most preferably in the range of 1.8-3. It is noted that maltodextrins having a DE of 1-4 are often referred to as “dextrins”.

The maltodextrin employed in accordance with the present invention may originate from different starch sources, such as potato, tapioca or corn (e.g. maize or wheat). Preferably the maltodextrin used in the bakery emulsion is a hydrolyzed potato starch.

The solid profile of the fat phase of the bakery emulsion to a large extent determines the hadling properties of the dough in which it is used as well as the eating quality of the final puff pastry. The solid fat content at 20° C. (N₂₀) preferably is at least 30%, more preferably at least 35%. Typically the N₂₀ does not exceed 50%, more preferably it does not exceed 48%. The solid fat content at 30° C. (N₃₀) preferably is at least 18%, more preferably at least 20%. Advantageously, the N₃₀ does not exceed 35%, more preferably it does not exceed 32%. The solid fat content at 35° C. (N₃₅) advantageously is at least 8%, especially at least 10%. Typically, the N₃₅ does not exceed 30%, more preferably it does not exceed 28%.

The fat phase of the bakery emulsion typically has an N₂₀:N₃₅ ratio in the range of 1.5:1 to 3.0:1, more preferably of 1.7:1 to 2.5:1.

According to a particularly preferred embodiment of the invention, the emulsifier employed in the bakery emulsion includes a glyceride emulsifier. Even more preferably, the emulsion contains 0.3-2.0% by weight of the fat phase of glycerides selected from monoglycerides, diglycerides and combinations thereof.

In accordance with another advantageous embodiment, the bakery emulsion contains a phospholipid emulsifier. Preferably, the emulsion contains 0.2-1.5% of phospholipids by weight of the fat phase.

The bakery emulsion according to the present invention preferably contains at least 0.5%, more preferably a least 1% salt by weight of the aqueous phase. Preferably, the salt content of the aqueous phase does not exceed 5 wt. %, most preferably said content does not exceed 3 wt. %.

The aqueous phase of the bakery emulsion is preferably acidified. Advantageously, said aqueous phase has a pH in the range of 2.5-5.5. Even more preferably, the pH of the aqueous phase does not exceed 5.0.

The fat content of the bakery emulsion of the present invention preferably it substantially lower than the fat content of fat products that are usually employed in the preparation of puff pastry. Accordingly, in accordance with a particularly advantageous embodiment of the invention, the bakery emulsion contains 50-62 wt. % of a continuous fat phase and 38-50 wt. % of a dispersed aqueous phase.

As explained herein before, the aqueous phase of the present emulsion may contain other hydrocolloids besides maltodextrin. Examples of such hydrocolloids include polysaccharide thickeners, polysaccharide gelling agents and proteins (including thickening and gelling proteins, such as gelatin). Preferably, the amount of other hydrocolloids does not exceed 2.0% by weight of the aqueous phase.

Advantageously, the bakery emulsion of the present invention contains not more than a limited amount of polysaccharides other than maltodextrin. Accordingly, the emulsion preferably contains less than 0.5% by weight of the aqueous phase, more preferably less than 0.1% by weight of the aqueous phase of polysaccharides other than maltodextrin.

The bakery emulsion may suitably contain non-polysaccharide hydrocolloids such as protein hydrocolloids. Preferably, also the amount of protein hydrocolloid contained in the aqueous phase is limited. Hence, in another preferred embodiment the aqueous phase contains less than 2.0%, preferably less than 1.0% of protein hydrocolloid by weight of the aqueous phase.

The hardness of the bakery emulsion of the present invention is strongly correlated with the handling of puff pastry dough that is prepared with said emulsion. According to a particularly preferred embodiment, the emulsion has a hardness at 20° C. of 200-900 g, more preferably of 350-700 g, said hardness being determined by measuring the maximum force (in g) that is required to penetrate the bakery emulsion with a probe cylinder having a diameter of 4.4 mm to a penetration depth of 10 mm at a penetration speed of 2 mm/s.

Another aspect of the present invention relates to a process of preparing a puff pastry dough, said process comprising employing incorporating into said dough or batter 50-120% by weight of flour of a bakery emulsion as defined herein before.

As explained herein before, the bakery emulsion may be employed in different methods for preparing puff pasty, including the so called French method and the so called Dutch method. Accordingly, one embodiment of the present invention is a process in which the dough is prepared in accordance with the French method by:
a) providing a sheet of farinaceous dough;
b) applying the bakery emulsion onto said sheet;
c) folding the sheet carrying the bakery emulsion;
d) sheeting the folded layer; and
e) repeating steps b) to d) for at least 1 time, preferably for at least 2 times.

An alternative embodiment relates to a process in which the dough is prepared in accordance with the Dutch method by:
a) combining the dry ingredients of the dough with discrete pieces of the bakery emulsion;
b) adding the liquid ingredients and processing the resulting blend into a dough that contains discrete lumps of the bakery emulsion; and
c) folding and sheeting the dough so obtained at least 1 time, preferably at least 2 times and even more preferably at least 3 times.

Yet another aspect of the present invention relate to a puff pastry dough that is obtained by a dough preparation process as defined herein before.

The puff pastry dough obtained by a process as described herein before is suitably baked in an oven that has been heated to 170-270° C., preferably to 180-255° C. Baking time typically lies within the range of 10-30 minutes, more preferably within the range of 15-25 minutes.

The invention also encompasses a puff pastry that is obtained by a dough preparation and baking process as defined herein before.

The invention is further illustrated by means of the following non-limiting examples.

### EXAMPLES

### Example 1

A low fat bakery emulsion was prepared on the basis of the recipe described in Table 1.

TABLE 1

| | Wt. % |
|---|---|
| Fat | 55.0 |
| Monoglyceride (Myverol ® 1804) | 0.6 |
| Lecithin | 0.3 |
| Flavouring, colouring, anti-oxidant | 0.1 |
| Maltodextrin (DE 2-3)¹ | 14.0 |
| Salt | 1.0 |
| Potassium sorbate | 0.1 |
| Water (acidified) | Remainder |

¹C*DryLight 01970 (Cargill)

The fat used in the low fat bakery emulsion had the following solid fat profile:

| | |
|---|---|
| N₂₀ | 40.2 |
| N₃₀ | 24.8 |
| N₃₅ | 20.2 |

The bakery emulsion was prepared as follows:
The fat was molten by heating it to 60° C.;
Emulsifiers, colouring, flavouring and antioxidant were added to the molten fat;
Maltodextrin was added to the fat phase under vigorous stirring;
The aqueous phase was prepared by adding salt, flavouring, sorbate, and acid to tap water at a temperature of 55° C. The pH of the aqueous phase was 3.8.
The aqueous phase was added to the fat phase under vigorous stirring. Stirring was continued for 20 minutes;
The emulsion was heated in a plate heat exchanger before being fed to a combination of scrape surface heat exchangers and crystallisers;
The plastic low fat bakery emulsion so produced was packaged in a wrapper.

### Example 2

A low fat bakery margarine was produced in the same way as described in Example 1, except that the maltodextrin concentration was lowered to 9 wt. % (20% by weight of aqueous phase) by replacing maltodextrin with water.

### Example 3

A low fat bakery margarine was produced in the same way as described in Example 1, except that the maltodextrin concentration was lowered to 5 wt. % (11.1% by weight of aqueous phase) by replacing maltodextrin with water.

### Example 4

A low fat bakery margarine was produced in the same way as described in Example 1, except that the maltodextrin was replaced completely with water.

### Example 5

The low fat bakery emulsions described in Examples 1-4 and a full fat (80 wt. % fat) puff pastry margarine were used to prepare patty shells using the recipe, equipment and procedure described below.

| Ingredients | |
|---|---|
| Flour | 1000 g |
| Salt | 25 g |
| Water | 600 g |
| Bakery emulsion | 800 g |

### Equipment

Diosna spiral kneaders SP-24F (dough capacity 24 kg)
Laminating machine (Fritsch, Roll-fix 60-650 e)
Patty shell cutter (Ø_{outside}: 8.5 cm, Ø_{inside}: 5.5 cm)

### Procedure

Mix flour, salt and water for 2 minutes at speed 1 and 2 minutes at speed 2. Allow the dough rest for 30 minutes at 20° C., covered with plastic
Laminate dough till 7 mm (roll-fix program 5).
Place the margarine in the center of the dough and fold in. Turn 90° (slot upwards and parallel with table)
Give 2 turns:
   Laminate dough till 7 mm. (roll-fix program 5)
   Fold in 4. Turn 90°.
   Laminate dough till 7 mm. (roll-fix program 5)
   Fold in 3. Turn 90°.
Let the dough rest for 30 minutes at 20° C. covered with plastic sheet.
Give 2 turns:
   Laminate dough till 7 mm. (roll-fix program 5)
   Fold in 4. Turn 90°. L
   Laminate dough till 7 mm. (roll-fix program 5)
   Fold in 3. Turn 90°.
Laminate the dough till 4 mm (roll-fix program 3).
Cut ⅔ of sheet, place on table. Use the 4 mm laminate to make shell tops.
Laminate the other ⅓ part till 2.5 mm, place on table, pin over, and brush slightly with water. Use this part to make shell bottoms.
Use an automatic cutter to make patty shells.
Arrange 12 patties on a tray.
Let patties rest for 1 hour.
Bake at upper 255° C. and lower 210° C. over 20 minutes open the key after 15 minutes

The patty shells so obtained were evaluated in terms of gravity index, oven lift, lamination structure, crispiness and mouthfeel. The lamination structure, crispiness and mouthfeel were assessed by an expert panel, using a rating scale of 1-5. The results of these evaluations are shown in the following table.

| | Example 1 | Example 2 | Example 3 | Example 4 | Reference |
|---|---|---|---|---|---|
| Gravity | 1.19 mm/g | 1.19 mm/g | 0.96 mm/g | 0.95 mm/g | 1.12 mm/g |
| Index | | | | | |
| Oven lift | 40 mm | 37 mm | 32 mm | 29 mm | 34 mm |
| Lamination | 3.0 | 3.0 | 2.0 | 2.0 | 2.5 |
| structure | | | | | |
| Crispiness | 4.0 | 4.0 | 1.5 | 2.0 | 3.4 |
| Mouthfeel | 3.0 | 2.0 | 2.5 | 2.5 | 2.6 |

These results show that the low fat bakery emulsions containing 9 wt. % or 14 wt. % of matlodetrin (DE 2-3) performed substantially better than the low fat bakery emulsion containing 5 wt. % of the same maltodextrin or no maltodextrin at all.

Best results were obtained with the low fat bakery emulsion that contained 14 wt. % of maltodextrin (31.1% by weight of aqueous phase).

The results further showed that the low fat bakery emulsion containing 14 wt. % of maltodextrin performed equally well as a standard, full-fat puff pastry margarine.

1-15. (canceled)

16. A reduced fat bakery emulsion comprising 39-65 wt. % of a continuous fat phase and 35-61 wt. % of a dispersed aqueous phase, said aqueous phase comprising:
(a) 60-80 wt. % of water;
(b) 18-40 wt. % of maltodextrin with a DE in the range of 1-5;
(c) 0-5 wt. % of other hydrocolloids;
(d) 0-6 wt. % of dissolved components selected from acids, salts and combinations thereof;
(e) 0-2 wt. % of other edible ingredients;
said continuous fat phase comprising:
(a) 94-99.5 wt. % of triglycerides;
(b) 0.5-5 wt. % of emulsifier selected from monoglycerides; diglycerides; phospholipids; esters of mono- and/or diglycerides and an acid selected from acetic acid, lactic acid, citric acid, tartaric acid and diacetyl tartaric acid, sugar esters of fatty acids, polyglycerol esters of fatty acids, polyglycerol polyricinoleate, propyleneglycol esters of fatty acids, sorbitan esters of fatty acids, stearoyl lactate and combinations thereof;
(c) 0-2 wt. % of other edible ingredients;
wherein the fat phase comprises a solid fat profile having:
(i) 25%≦N₂₀≦50;
(ii) 15%≦N₃₀≦35%; and
(iii) 5%≦N₃₅≦30%.

17. The bakery emulsion according to claim 16, wherein the emulsion comprises 20-36 wt. % of the maltodextrin by weight of the aqueous phase.

18. The bakery emulsion according to claim 16, wherein the maltodextrin has a DE in the range of 1.5-4.

19. The bakery emulsion according to claim 18, wherein the maltodextrin has a DE in the range of 1.8-3.

20. The bakery emulsion according to claim 16, wherein the maltodextrin is a hydrolyzed potato starch.

21. The bakery emulsion according to claim 16, wherein the fat phase comprises a solid fat profile having:
(i) 30%≦N₂₀≦50%;
(ii) 18%≦N₃₀≦35%;
(iii) 8%≦N₃₅≦30%.

22. The bakery emulsion according to claim 16, wherein the fat phase has an N₂₀:N₃₅ ratio in the range of 1.5:1 to 3.0:1.

23. The bakery emulsion according to claim 22, wherein the fat phase has an N₂₀:N₃₅ ratio in the range of 1.7:1 to 2.5:1.

24. The bakery emulsion according to claim 16, wherein the emulsion comprises 0.3-2.0% by weight of the fat phase of glycerides selected from monoglycerides, diglycerides and combinations thereof.

25. The bakery emulsion according to claim 16, wherein the emulsion comprises 0.2-1.5% of phospholipids by weight of the fat phase.

26. The bakery emulsion according to claim 16, wherein the emulsion comprises 50-62 wt. % of the continuous fat phase and 38-50 wt. % of the dispersed aqueous phase.

27. The bakery emulsion according to claim 16, wherein the emulsion comprises less than 0.5% by weight of the aqueous phase.

28. The bakery emulsion according to claim 16, wherein the aqueous phase comprises less than 2.0%.

29. The bakery emulsion according to claim 16, wherein said emulsion has a hardness at 20° C. of 350-700 g, said hardness being determined using a probe cylinder having a diameter of 4.4-mm, a penetration depth of 10 mm and a penetration speed of 2 mm/s.

30. A process of preparing a puff pastry dough, said process comprising incorporating into a dough or batter 50-120% by weight of flour of a bakery emulsion according to claim 16.

31. The process according to claim 30, wherein the dough is prepared by:
a) providing a sheet of farinaceous dough;
b) applying the bakery emulsion onto said sheet;
c) folding the sheet carrying the bakery emulsion;
d) sheeting the folded layer; and
e) repeating steps b) to d) for at least 1 time.

32. The process according to claim 30, wherein the dough is prepared by:
a) combining the dry ingredients of the dough with discrete pieces of the bakery emulsion;
b) adding the liquid ingredients and processing the resulting blend into a dough that contains discrete lumps of the bakery emulsion;
c) folding and sheeting the dough so obtained at least 1 time.
